(19) United States
(12) Patent Application Publication
(10) Pub. No.: US 2009/0065404 A1
(43) Pub. Date: Mar. 12, 2009

(54) PROCESS FOR RECLAIMING MULTIPLE DOMAIN FEEDSTOCKS

(75) Inventors: Stephen C. Paspek, JR., Broadview Heights, OH (US); Joseph E. Bork, Westlake, OH (US); Alan Schroeder, Cleveland, OH (US)

Correspondence Address: RANKIN, HILL & CLARK LLP, 38210 Glenn Avenue, WILLOUGHBY, OH, 44094-7808, US

(73) Assignee: PASPEK CONSULTING LLC, Broadview Heights, OH (US)

(21) Appl. No.: 12/264,977

(22) Filed: Nov. 5, 2008

Related U.S. Application Data
(63) Continuation-in-part of application No. 11/301,003, filed on Dec. 12, 2005.
Application No. 11/301,003 is a continuation-in-part of application No. 11/047,114, filed on Jan. 31, 2005, now abandoned.
Application No. 11/047,114 is a continuation-in-part of application No. 10/774,158, filed on Feb. 6, 2004, now abandoned.
(60) Provisional application No. 60/985,303, filed on Nov. 5, 2007.

(51) Int. Cl. B03B 5/30; B03B 7/00

(52) U.S. Cl. 209/173; 209/659; 209/164

(57) ABSTRACT

A process for the separation of a multiple domain solid feedstock such as that derived from ASR, WSR, and/or ESR is disclosed which comprises granulating the feedstock to produce particles each of substantially a single domain, with each type of particle having a different density. The particles are introduced into a suitable aqueous salt solution. Aqueous salt solutions containing cations comprising sodium, calcium and ammonium, and anions comprising nitrate, bromide, and chloride are useful. A dispersion mixer having a high shear and/or turbulent zone is utilized to disperse agglomerated particles and a quiescent hydrogravity tank is utilized to effect binary separation of the mixture of particles into a stream with a higher average specific gravity, and a stream with a lower average specific gravity. A higher degree of product purity can be obtained by subjecting either of the product streams from the first hydrogravity stage to additional stages of hydrogravity separation. Froth flotation may be used to further separate particles of similar specific gravity but different chemical composition.

### CROSS REFERENCES TO RELATED APPLICATIONS

This application is a continuation-in-part (CIP) application of U.S. application Ser. No. 11/301,003 filed on Dec. 12, 2005 which is a continuation-in-part (CIP) of U.S. application Ser. No. 11/047,114 filed on Jan. 31, 2005, now abandoned, which is a continuation-in-part (CIP) of application Ser. No. 10/774,158 filed on Feb. 6, 2004, now abandoned. This application also claims priority from U.S. provisional application Ser. No. 60/985,303 filed Nov. 5, 2007.

### FIELD OF THE INVENTION

The present invention relates to reclaiming one or more solid components, such as various plastics, metals, etc. from a multiple domain solid feedstock such as automobile shredder residue (ASR), electronics shredder residue (ESR), appliance and white goods shredder residue (WSR), or other mixed materials. Particulate streams containing broad mixtures of plastics, metals, wood and fiber have very little use or value. However, by separating and purifying each of the individual components or classes of components, one can increase both the utility and value of the particulates.

### BACKGROUND OF THE INVENTION

In the separation arts, and particularly in the fields of reclamation and recycling of plastics and various polymeric materials, a wide array of separation strategies are known.

Density-based separations such as float-sink or hydrogravity operations are known in which a mixed feed including multiple materials having different densities is introduced to a liquid having a density within the range of densities of the mixed feed. As will be appreciated, materials having a density less than that of the medium will rise, and materials having a density greater than that of the medium will sink, thereby enabling a separation between the two classes of materials. Typically, the liquid medium used in such float-sink operations is water.

For density-based separations in which it is desired to separate classes of materials about a density value greater than that of water, various additives can be added to the aqueous medium to form a slurry having an increased density. Examples of these additives include, but are not limited to, various clays, insoluble minerals, glass powders, and metallic powders. Numerous patent documents describe forming high density slurries for these types of separations, such as in U.S. Pat. Nos. 3,857,489; 6,460,788 and US patent application publications 2007/0272597 and 2007/0138064. Although satisfactory in certain regards, the use of slurries as a density-separation medium typically raises a host of additional concerns such as ensuring uniform dispersal of the particles throughout the liquid, and maintaining stability of the slurry once formed.

It is also known to increase the density of a liquid medium in a float-sink operation by adding one or more soluble density-adjusting agents that dissolve in the liquid medium. Examples of density-based separations using dissolved salts include U.S. Pat. Nos. 5,236,603; 5,653,867; and 6,460,788. Although the use of dissolved agents avoids many of the problems associated with using slurries of dispersed powders in a liquid medium, further improvements in these techniques would be desirable.

### SUMMARY OF THE INVENTION

The difficulties and drawbacks associated with previous approaches are overcome in the present methods for separating or recovering materials.

In one aspect, the present invention provides a process for separating two or more types of multiple domain feedstock particles. The process consists essentially of reducing a feedstock particle size sufficiently to create largely single-domain particles and a particle size distribution suitable for processing. The process also consists essentially of optionally cleaning the particles with air and/or aqueous solutions to remove contaminants and fines. The process also consists essentially of dispersing the particles into an aqueous solution having a specific gravity between that of the lightest and the heaviest particles in the feedstock. The process also consists essentially of using a dispersion mixer to create a uniform dispersion of individual particles in the aqueous solution. The process further consists essentially of separating the feedstock particles into individual components or classes of components based on specific gravity using one or more stages to achieve desired recovery and purity. And, the process further consists essentially of optionally separating particles or classes of particles of similar specific gravity using one or more stages of froth flotation to achieve desired recovery and purity. The aqueous solution comprises cations selected from the group consisting of potassium, calcium, sodium, ammonium, and combinations thereof, and further comprises anions selected from the group consisting of nitrate, chloride, bromide, and combinations thereof, at concentrations sufficient to create a fluid with a specific gravity greater than 1.001 relative to the specific gravity of pure water.

In another aspect, the present invention provides a process for separating two or more types of multiple domain feedstock particles. The process consists essentially of reducing the feedstock particle size sufficiently to create largely single-domain particles and a particle size distribution suitable for processing. The process may optionally include cleaning the particles with air and/or aqueous solutions to remove contaminants and fines. The process further consists essentially of dispersing the particles into an aqueous solution having a specific gravity between that of the lightest and the heaviest particles in the feedstock. The process also consists essentially of using a dispersion mixer to create a uniform dispersion of individual particles in the aqueous solution. And, the process consists essentially of separating the feedstock particles into individual components or classes of components based on specific gravity using one or more stages to achieve desired recovery and purity. The process also consists essentially of optionally separating particles or classes of particles of similar specific gravity using one or more stages of froth flotation to achieve desired recovery and purity. The aqueous solution comprises an agent selected from the group consisting of alcohols, glycols, ethers, other water-soluble organics, and combinations thereof, with a specific gravity less than 1.0.

In yet another aspect, the present invention provides a process for producing a plurality of outputs from a particulate feed including a plurality of materials. The process comprises introducing the particulate feed to a first hydrogravity vessel containing a liquid medium having a density within the range of densities of the plurality of materials in the feed, whereby a first output is formed that includes the materials having densities less than the density of the liquid medium, and a second output is formed that includes the materials having densities greater than the density of the liquid medium. The process also comprises introducing one of the first output and the second output from the first hydrogravity vessel to a second hydrogravity vessel containing a liquid medium having a density substantially the same as the density of the liquid in the first hydrogravity vessel. A third output is formed that includes materials having densities less than the density of the liquid medium in the second hydrogravity tank. In addition, a fourth output is formed that includes materials having densities greater than the density of the liquid medium in the second hydrogravity tank.

And in another aspect, the present invention provides a process for recovering a first material from a feedstock comprising the first material and a second material having a density that is the same or similar as the density of the first material, and a third material having a density that is different than the density of the first material. The process comprises introducing the feedstock to a float-sink system including a tank containing an aqueous medium comprising cations selected from the group consisting of potassium, calcium, sodium, ammonium, and combinations thereof, and anions selected from the group consisting of nitrate, chloride, bromide, and combinations thereof. The process also comprises separating the feedstock in the float-sink system into a first output comprising the first material and the second material, and a second output comprising the third material. And, the process comprises directing the first output comprising the first material and the second material to a froth flotation system including a vessel containing an aerated liquid medium. The process further comprises separating the first material and the second material in the froth flotation system into a second output comprising the first material and a third output comprising the second material.

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIG. 1 is a graph illustrating changes in specific gravity of an aqueous solution as the weight percentage of calcium nitrate added thereto increases.

FIG. 2 is a graph illustrating changes in specific gravity of an aqueous solution as the weight percentage of a combination of calcium salts added thereto increases.

FIG. 3 is a process block flow diagram of a preferred embodiment process according to the present invention.

FIG. 4 is a process block flow diagram of another preferred embodiment process according to the present invention.

FIG. 5 is a process block flow diagram of yet another preferred embodiment process according to the present invention.

FIG. 6 is a process block flow diagram of a froth flotation unit utilized in association with the present invention.

FIG. 7 is a process block flow diagram illustrating a system of multiple froth flotation units utilized in association with the present invention.

### DETAILED DESCRIPTION OF THE EMBODIMENTS

The present invention provides a particular combination and series of operations including sizing and/or cleaning if warranted, specific gravity separation, and optional froth flotation. These steps allow separation by both particle density and by particle surface characteristics. The combination of these operations renders the preferred embodiment processes economical and robust, such that nearly any type of multiple domain stream can be separated into components of increased value.

Specifically, the present invention provides processes for separating two or more types of feedstock particles derived from a multiple domain feedstock such as automotive shredder residue (ASR), electronic shredder residue (ESR), appliance and white goods shredder residue (WSR) and/or other mixed materials. The processes comprise a number of steps, some of which may be optional depending on the type of separation required for a particular mixture.

The preferred embodiment processes include granulation to create particles of a desired size for processing. The processes also include separating multiple domain particles into single domains. The processes may include optional aspiration, screening, and washing to remove waste materials and dust. The processes also include dispersing the particles into an aqueous salt solution having a specific gravity between that of the lightest and the heaviest particles in the feedstock. The processes further include classification and separation of particles by specific gravity using a float-sink or hydrogravity tank such that most of the particles with a specific gravity less than that of the fluid will float, and most of the particles with a specific gravity greater than that of the fluid will sink. The processes also include removing the floating particles from the hydrogravity tank to form a first product stream and removing the sinking particles from the hydrogravity tank to form a second product stream. The processes may also include optionally repeating the specific gravity separation steps one or more times on either the first and/or second product streams using either a fluid with the same or substantially the same specific gravity to improve product purity, or a different specific gravity to affect another specific gravity based separation. Furthermore, the processes may also include optional separation of particles of the same specific gravity range by froth flotation, which differentiates based on particle surface chemistry. And, the processes may also include fluid cleaning and balancing to maintain the appropriate fluid quality (cleanliness, surface tension, etc.) and density.

For the specific gravity separation, it has been discovered that a salt solution including one or more types of cations such as potassium, calcium, sodium, and ammonium, and one or more types of anions such as nitrate, chloride, and bromide are especially effective in this application. It has been surprisingly discovered that the use of this particular combination of cations and anions to increase the density of the resulting medium, enables an efficient and economical separation of materials.

Although different salt solutions can be used in different float-sink tanks, it is often convenient to use a single salt solution in all of the tanks to simplify fluid management. The density of the solution can be easily altered by altering the weight percent salt in the solution via concentration or dilution. To effect multiple particle separations, it is convenient to use a solution whose density can be easily altered over a wide range. To create a fluid that can be formulated to produce a broad range of densities, it is desirable to select a salt solution that is a liquid over a broad range of temperatures and weight percent solids.

As noted, it has been discovered that salt solutions comprising one or more types of cations including potassium, calcium, sodium, and ammonium, and one or more types of anions including nitrate, chloride, and bromide are especially effective for these applications.

The various preferred embodiment processes of the present invention are directed to reclaiming individual components or classes of components from a multiple domain solid feedstock such as one or more of ASR, ESR, and/or WSR, using aqueous salt solutions of various specific gravities to separate particles into multiple product streams based on the particle specific gravities, and optionally further using froth flotation to separate mixtures of particles with the same or substantially the same specific gravities but different surface chemistries.

### Process Feedstocks

Examples of articles or products utilized as multiple domain feedstocks in various embodiments of the invention include, but are not limited to, the residue derived from the shredding of automobiles (ASR), appliance and white goods (WSR), electronic equipment (ESR), and combinations thereof. The particle top size is usually less than 6 inches. Often, much of the ferrous metal such as for example iron, steel, etc., has been removed from this residue and usually by magnetic means. In some cases, some of the non-ferrous metal, such as for example copper, zinc, aluminum, stainless steel, etc., has also been removed, often by some type of eddy-current separation. However, it is usually impossible to remove all of the ferrous and/or non-ferrous metals by conventional processing. This residual metal contaminates the plastics that make up the majority of ASR, WSR, and ESR, and must be removed to allow facile recycling of the plastics.

Examples of specific thermoplastic polymers which can be separated include, but are not limited to, polyolefins, polyurethanes, polyamides, polyvinyl chlorides, styrenic polymers, acrylic polymers, polycarbonates, fluorinated polymers, polyesters, and ABS. Virtually all of these polymers are present as compounds, containing additives such as inorganic fillers, plasticizers, colorants, impact modifiers, stiffeners, and the like.

The multiple domains may be initially joined together, but must be capable of being separated into largely single-domain particles through some means of grinding, chopping, shredding, etc.

### Types of Separation

The preferred embodiment processes can be used to separate classes of materials or to isolate specific components of a mixture.

For example, a fluid of a certain specific gravity may be used to separate the majority of the plastic components in a multiple domain feedstock such as that derived from ASR, WSR, and/or ESR from the metallic components therein, thereby separating the “metallic” class from the “plastic” class.

Plastic components can also be separated from various other non-plastic components, including foams and fibers, various cellulosic materials such as wood and paper, various rubbers and thermoplastic elastomers, tars, dirt, sand, glass, fabrics and other contaminants by air washing (aspiration) or by specific gravity separation in an aqueous salt solution.

Specific gravity or density separation may also be used to separate the plastic components into streams of pure single-component plastics, or into two streams of multi-component plastics such that all of the components in a stream have essentially the same specific gravity, or have specific gravities within a narrow range of each other.

Plastic particles of similar specific gravity but different chemical composition can be separated based on differences in surface chemistry by using froth flotation.

### Preferred Embodiment Processes

The overall process preferably includes, but is not limited to, the following operational steps described in more detail below.

### Granulation

A particle or artifact used as a feed to this process may contain multiple domains. These multiple domains are often present in the form of layers, regions, areas, and the like. The term “domain” as used herein, refers to a portion of material which has the same or nearly the same, density or specific gravity. To effect a separation of different domains by float-sink technology, it is necessary to first physically separate the domains. This can be accomplished through various mechanical means such as granulating, grinding, chopping, ball milling, hammer milling, and the like known to those skilled in the art.

Granulators such as those made by Cumberland of South Attleboro, Mass. or shredders such as those made by SSI of Wilsonville, Oreg. are particularly useful in this step. Granulation involves sizing the feed stock by cutting or chopping the feedstock into suitably-sized particles of substantially single domains. Furthermore, the largest particles must be sufficiently small enough to pass through any pumps, control valves, flow meters, etc. Particles less than 1 inch in their largest dimension are useful, and particles less than about 0.25 inches in their largest dimension are preferred.

Depending on the as-received quality of a given feedstock, granulation may be an optional step if the particle size distribution is sufficiently small, and if the particles are all substantially a single domain.

### Aspiration and Screening

The properly sized particles can be aspirated and/or screened to remove fines, foam and fiber. Suitable aspirators include the waterfall type manufactured by Kice Industries, Inc. of Wichita, Kans. and Forsberg of Thief River Falls, Minn. Suitable screeners include round screeners such as those manufactured by Sweco of Florence, Ky. or rectangular screeners such as those manufactured by Rotex of Cincinnati, Ohio.

Removal of contaminants and trash at this point in the process protects the fluids in subsequent steps from excessive contamination and reduces, but not eliminates the need for fluid clean-up. Removal of fine particles, typically those less than about 0.5 mm, is also important, since small particles have a very low Stokes velocity, and will require excessive amounts of time to separate in the subsequent specific gravity separation steps.

For high quality feedstocks that contain minimal amounts of paper, fines, fibers, etc. this step may be optional.

### Washing

Another optional step involves washing the particles using water or an aqueous solution, optionally containing a suitable surfactant, to remove dirt, dust, grime, oil, and the like, yielding a more pure product. A means of mixing and agitation is useful in promoting solid-liquid contacting. Particle-to-particle contact can also aid in removing and suspending dirt and oil particles in the washing fluid. Rinsing and/or spin drying can be useful after the washing step to reduce the amount of residual fluids carried forward to the next step.

Feedstocks that contain minimal amounts of dirt, oil, etc., or feedstocks that have been previously subjected to some type of washing may not require this step.

### Hydrogravity Separation

The particles are then introduced into an aqueous solution having a specific gravity or density which is intermediate to the specific gravity of the heaviest solid components and the lightest solid components in the feed to this stage. The mixture of particles and aqueous solution is passed through one or more hydrogravity processing units. Each processing unit preferably contains a dispersion mixer to disperse any agglomerated particles, and a relatively quiescent hydrogravity separation tank which allows heavy components to sink and lighter components to float.

The dispersion mixer is used to sever, divide, and especially to break up agglomerated particles of the feedstock before they are added to a hydrogravity separation tank. A number of devices can be used as a dispersion mixer, including an agitated tank, an in-line static mixer, an in-line mechanical mixer, a high sheer pump such as a centrifugical pump, or any other device that serves to physically separate the mixture into individual particles.

It is important that each particle be free to float or sink as its specific gravity and the specific gravity of the process fluid dictates. If a heavy particle and a light particle were to remain agglomerated together, and were to report to either product stream, the agglomerate would introduce some measure of impurity into that product stream by virtue of the other particle in the agglomerate.

The actual hydrogravity separation occurs in a largely quiescent tank preferably having steep angled walls generally greater than the angle of repose of the heavy particles to prevent particle build-up thereon. A heavy product is recovered from the bottom of the tank, and a light product is recovered from the upper portion of the tank.

However, after one stage of hydrogravity separation, the floating and/or sinking product streams may not be sufficiently pure. Either of the product streams may be contaminated with some entrained particles that would have moved in the opposite direction but for the mass action of other particles surrounding it. Therefore, multiple hydrogravity separations using a fluid of the same or substantially the same specific gravity may be required to achieve a reasonably pure product. This is analogous to the multiple separation stages that occur in a distillation column to produce a pure liquid stream.

By way of example, assume a two-component feedstock and a hydrogravity separation efficiency of 90%. After one stage of separation, the desired product stream will contain about 90% of the desired product, and about 10% of the other material as a “contaminant”. After a second stage of hydrogravity separation, the level of contamination is reduced to 1%. After a third stage of hydrogravity separation, the level of contamination is reduced to 0.1%, and after a fourth stage of hydrogravity separation, the level of contamination is reduced to 0.01%.

As noted, it is preferred that the specific gravity in two or more hydrogravity tanks in a system comprising a plurality of such tanks contain liquid mediums having the same or substantially the same specific gravities (or densities). The term “substantially the same” refers to average specific gravity values that are within about 15%, preferably about 10%, and more preferably about 5% of each other. Typically, liquid mediums exhibiting the same or substantially the same specific gravities will also exhibit the same or substantially the same chemical compositions, and so, will utilize the same density adjusting soluble salts described herein.

One process configuration includes two or more groups of hydrogravity stages, with each group of hydrogravity stages using a fluid with the same or substantially the same specific gravity. Different groups of hydrogravity stages can be operated using fluids of different specific gravities.

It is possible to arrange a series of hydrogravity tank groups so that the specific gravity of the fluid increases as the particles move from one group of tanks to the next, or so that the specific gravity of the fluids decreases as the particles move from one group of tanks to another.

For some feedstocks, it may be preferable to introduce the feedstock in the middle of series of hydrogravity tank groups such that some of the particles move into fluids of decreasing density, while other particles more into fluids of increasing density. Such an arrangement is used to minimize exposure of lighter components to the heaviest fluids (i.e. highest specific gravity fluids), minimizing the loss of these higher viscosity and often higher cost fluids.

Particles in product streams exiting the hydrogravity process may optionally be rinsed and/or dried to remove residual aqueous salt solution and water. However, as described herein, it may in many instances be preferred to avoid such intermediate operations, and simply direct the output(s) from the hydrogravity process directly to a froth flotation operation.

### Aqueous Mediums for Specific Gravity Separation

The density or specific gravity based separations described herein, such as a float-sink operation, typically utilize a liquid medium. That medium is preferably an aqueous medium, and more preferably an aqueous solution. The liquid medium, aqueous medium, and aqueous solution, in certain applications are preferably free from insoluble materials. In this context, the term “insoluble materials” does not refer to the materials to be separated via the float-sink operation. Instead, that term refers to other materials such as the previously noted density-adjusting powders that are not soluble in, or do not dissolve in, the liquid medium. Thus, the term “free from insoluble materials” as used herein is with regard to liquid mediums that do not include any insoluble materials or powders such as density-increasing clays or other materials.

The elevated specific gravity of the aqueous hydrogravity solution (relative to water) can be achieved by adding one or more inorganic salts to water to achieve a specific gravity greater than one.

As previously noted, it has been found that salt solutions containing one or more types of cations including potassium, calcium, sodium, and ammonium, and one or more types of anions including nitrate, chloride, and bromide are especially effective for this application. The use of liquid mediums comprising these ions in a density-based separation operation has surprisingly been discovered to enable efficient, economical, and convenient separations.

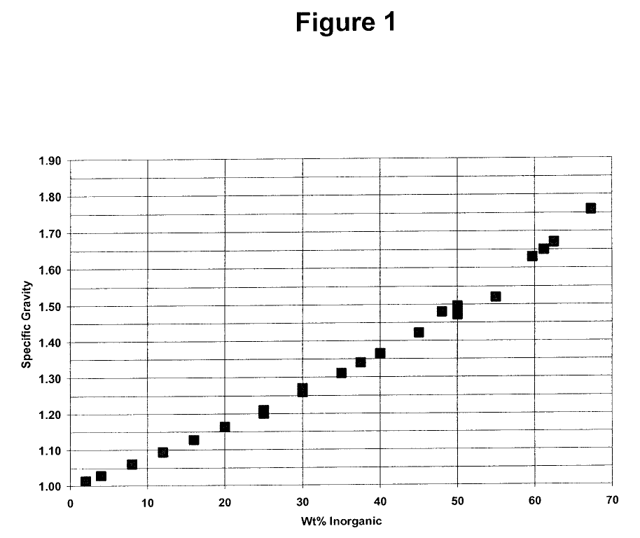

Solutions of calcium nitrate at a temperature of about 110° F. can be adjusted to have a specific gravity of 1.00 to about 1.80 by altering the weight percent of salt in the solution over a range of 0 to about 70%. A plot of calcium nitrate density as a function of the weight percent of salt in the solution is shown in FIG. 1.

Calcium nitrate can be purchased as an aqueous solution with a specific gravity of about 1.50 or as the trihydrate or tetrahydrate solid salt from companies such as Golden Eagle Products in Carey, Ohio. The solution density can be increased by adding more solid calcium nitrate, or by evaporation of the water. The solution density can be decreased by adding more water.

A mixture of mostly calcium nitrate with some ammonium nitrate is sold in solid form by Yara, a Norwegian company through The Andersons, a Toledo, Ohio distributor. It is used primarily as a crop fertilizer, and as a spray to prevent bitter pith in apples. This “double” nitrate salt is used primarily as a fertilizer and fruit tree spray. It is less expensive than the “single salt” calcium nitrate, and is just as effective as calcium nitrate for the purposes of the present invention.

Calcium nitrate solutions are relatively benign compared to other high density salt solutions, and pose minimal environmental hazard. In fact, many municipalities actually add calcium nitrate to their sewage lines to control odor.

Calcium nitrate solutions are also far less corrosive than the equivalent calcium chloride solutions. In fact, calcium nitrate is added to some diesel fuels as a corrosion inhibitor.

Calcium nitrate can be manufactured from the reaction of nitric acid and lime. It is possible to create an aqueous salt solution for the present invention by mixing the proper stoichiometric amounts of calcium oxide (quick lime) or calcium hydroxide (slaked lime) with nitric acid and water. Densities can be adjusted through the addition or removal of water as required.

While it is possible to use other nitrate salts or other calcium based salts, calcium nitrate appears to offer the ability to create a very high specific gravity solution at a relatively low cost, without incurring the penalty of high solution viscosity, and without introducing less environmentally friendly cations such as Ba, Sr, Cs, heavy metals, etc.

Finally, calcium nitrate hydrated salts melt at about 105° F. This allows the use of low temperature evaporation for reconstituting spent solutions without fear of crystallization and plugging of the equipment, provided that the temperatures are maintained above 105° F.

Other non-nitrate salts, such as calcium bromide, calcium zinc bromide, cesium formate and sodium or lithium polytungstate offer even higher specific gravity solutions, but are significantly more expensive (some exceeding $100 per pound) and pose a greater potential environmental liability.

Salt solutions that contain more than one type of cation and more than one type of anion are particularly useful in this application, since such salt solutions can have a broader range of usable specific gravities at near-ambient temperatures. While not wishing to be bound to any particular theory, it is believed that using dissimilar sized anions or cations negatively impacts the stability of the crystal structure, inhibits crystallization of a salt, and causes higher concentrations of the cations and anions to remain in solution. One such example is a mixture of calcium chloride and calcium nitrate.

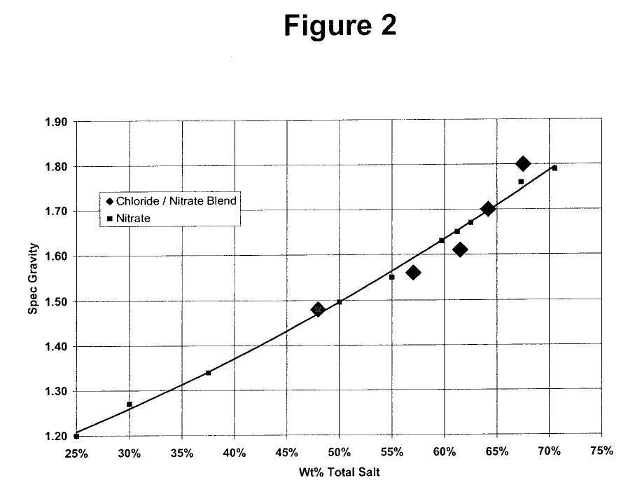

FIG. 2 compares the density of a calcium nitrate solution with that of a calcium nitrate/calcium chloride blend in solution. The blend measurements began with a 50% calcium nitrate solution at a specific gravity of about 1.50 to which increasing amounts of calcium chloride were added to increase the specific gravity.

Since calcium chloride is less expensive than calcium nitrate, the mixture offers a means of obtaining a high specific gravity solution at lower cost than with calcium nitrate alone. However, calcium chloride is more corrosive than calcium nitrate, and does form solid salt crystals if evaporated to dryness.

It is possible to create an aqueous solution containing calcium and nitrate ions from many starting materials. Regardless of the initial source of the ions, an aqueous solution rich in calcium and nitrate ions is a preferred solution for specific gravity separations in the present invention.

It is also important that the salt solution have a sufficiently low viscosity such that the particles in the hydrogravity tank can respond to buoyant forces in the processing time allowed. If the viscosity is too high, the particles will be unable to float or sink fast enough, and may fail to report to the proper product stream.

In certain applications, a small amount of a soap, surfactant, detergent, or wetting agent is desirably added to the aqueous salt solution to reduce surface tension, to reduce interfacial tension between the fluid and the particles, to promote the release of air bubbles and to reduce the attraction between particles. A low-foaming or non-foaming surfactant is desirable, since the attachment of bubbles to particles may result in the inadvertent floating of heavy particles that were expected to report to the heavy product stream, decreasing the hydrogravity separation efficiency. A mixture of a non-foaming surfactant, a low-foaming surfactant and an anti-foam agent has been found to be useful in this application.

The amount of such surfactants, detergents, wetting agents, defoamers, etc., generally varies with the strength of the surfactant, the amount of dirt or other contaminants in the feedstock, and the chemical nature of the aqueous salt solution.

For certain plastics, it may be useful to have an aqueous solution with a specific gravity less than 1.0 to effect the necessary specific gravity separation. Such fluids are especially useful in the separation of the lower specific gravity olefins. In such cases, in lieu of adding inorganic salts to increase the solution specific gravity, one would add water-miscible organics with a lower specific gravity. Mixtures of common alcohols such as methanol, ethanol, and isopropanol with water can be used to create fluids with specific gravities as low as 0.80 specific gravity units. Other water soluble organics include some organic acids, glycols, and ethers. Organics with high flash points are preferred to minimize fire hazard. Organics with low vapor pressures are preferred to minimize worker exposure. Diethylene glycol diethyl ether, ethylene glycol monobutyl ether, propylene glycol n-propyl ether are useful in these types of solutions.

### Maintenance of Aqueous Salt Solutions

It is important to maintain clean process fluids, i.e. aqueous salt solutions, to effect good particle separation. This involves removing dirt, fines, and any foreign solid materials. A number of methods can be used to continually or intermittently clean the fluids, such as clarification, centrifugation (solid bowl, screen bowl, or other), and filtration (gravity, pressure, or other). An excessive build-up of foreign particles in the process fluid can impair the ability of individual single domain particles to quickly move in the direction indicated by their specific gravity relative to the specific gravity of the process fluid.

In a preferred aspect of the present invention, it has been discovered that salt solutions of the types described herein can be cleaned by employing the following steps: 1) Addition of lime to raise the fluid pH above 8 and to provide ballast for the floc; 2) Addition of a polyacrylamide flocculant to gather suspended solids and lime into a larger agglomerate (floc) that can be more easily separated from the bulk solution by sedimentation; and 3) Separation of the floc from the bulk solution in a clarifier.

The clarifier bottoms, rich in decanted agglomerates, can be further de-solutioned in a filter press or centrifuge to reduce the disposal weight of the solids, and to recover additional salt solution. Often this impure solution is re-introduced into the inlet of the clarifier.

Diluted aqueous solutions from the process can be reconstituted continually or intermittently by evaporation, reverse osmosis, or by the addition of solid salts to increase their specific gravity. The low temperature evaporators sold by Poly Products of Cleveland, Ohio have been useful in this application.

Overly concentrated solutions can be diluted with water to reduce specific gravity.

### Optional Froth Flotation

As attention increases toward further purification and recovery of particular materials from complex mixtures of ground or comminuted particulates, such as ASR, ESR, or WSR; it may be desired to further subject an output of one or more separation operations such as a float-sink operation to a non-density based separation operation such as a froth flotation operation.

That is, the product streams from one or more multiple tanks, vessels, or stages of hydrogravity separation may still contain multiple types of particles each with similar specific gravities, but with different bulk and surface chemical characteristics. Such products or particles can be separated using froth flotation.

Froth flotation is a well known process that uses air bubbles to cause the more hydrophobic particles in a mixture to float to the surface of an aqueous liquid medium while the more hydrophilic particles tend to sink. Various chemicals can be added to improve bubble stability, change surface tension, and alter the surface properties of particles. Froth flotation causes particles to separate based on the relative hydrophobicity of a particle's surface, with the more hydrophobic particles adhering to the bubbles and reporting to the surface of the liquid, while the less hydrophobic particles (i.e. more hydrophilic particles) tend to “wet”, and sink in the process fluid.

Froth flotation differentiates between particles of similar specific gravity based on the relative hydrophobic or hydrophilic nature of the particle surface. By introducing air into an aqueous fluid, one creates a two-phase separation medium. The more hydrophilic particles tend to congregate into the bulk aqueous phase, while the more hydrophobic particles tend to report to the air-rich bubble phase. Certain chemicals can be added to the aqueous medium to enhance this separation.

In one example, a mixture of polyvinyl chloride (PVC) and rubber, both in the specific gravity range of 1.3 to 1.4 was separated using froth flotation. The particles were introduced into a tank containing water, a source of air, and a small amount of light hydrocarbon oil such as light mineral oil or a light vegetable oil such as soy bean oil, cotton seed oil, or linseed oil. The PVC particles preferentially reported to the surface of the fluid, while the rubber particles remained in suspension. The final PVC product contained less than 0.1 wt % rubber.

In another example, a mixture of polyvinyl chloride and filled polyethylene, both in the specific gravity range of 1.3 to 1.4 was separated using froth flotation. The particles were introduced into a tank containing water, a source of air, and a small amount of light hydrocarbon oil such as light mineral oil or a light vegetable oil such as soy bean oil, cotton seed oil, or linseed oil. The PVC particles preferentially reported to the surface of the fluid, while the filled polyethylene particles remained in suspension. The final PVC product contained less than 0.1 wt % filled polyethylene.

Generally, in accordance with the preferred embodiment processes, a particulate feedstock or feedstock stream from a density-based separation is introduced into a froth flotation unit or system. As noted, froth flotation involves the admixing of feedstock particles with water and air. A number of fabricators market froth flotation technology, including Wemco of FLSmidth Dorr-Oliver Eimco USA Inc., of Salt Lake City, Utah; Denver, which is available through Metso Minerals of Helsinki, Finland; and Outokumpu Mintek of Helsinki, Finland. Since the air in these units is introduced below the surface of the water, they are referred to as “sub aeration” devices. It is also possible to spray a fluid or a slurry onto the surface of a liquid, generating bubbles. These type of operations are referred to as “spray float”. In either case, a stream rich in hydrophobic particles is removed from the surface of the tank, and a stream rich in hydrophilic particles is removed from the bottom of the tank. The removal of particles maybe continuous or dis-continuous.

The units can be operated as batch, semi-continuous or continuous. They can be operated as single stage or multi-stage. They can be operated at different air flow rates, pressures, etc. They can be arranged into various classes of separation commonly referred to as “roughers”, “cleaners” and “scavengers”.

The yield and quality of the floating product stream is generally a function of the chemical composition of the particles in the feed mixture, the operating conditions of the froth flotation cell, and the type and quantity of chemicals added to the process to improve yield and selectivity.

A particularly useful means of introducing both the particles and air into a froth flotation system involves the spraying of a slurry through a nozzle at relatively high velocities so that the slurry impinges onto the surface of the fluid in a tank. This impingement results in the formation of many very fine bubbles that attach preferentially to the more hydrophobic particles, buoying them up. Skimmers are used to then scrape these particles off of the surface for recovery.

A pig-tail type of nozzle such as the type manufactured by Bete of Greenfield, Mass. for fire water sprays and other applications is particularly useful in this application.

As with specific gravity separation, multiple stages of froth flotation may be employed to improve yield, product quality, or both. These stages may be operated at the same operating conditions (temperature, impingement velocity, impingement angle, chemical addition rate, slurry pulp density, etc.) or at different operating conditions depending on the desired separation.

It should be emphasized that the above-described embodiments of the present disclosure are merely possible examples of implementations, set forth for a clearer understanding of the principles of the disclosure. Many variations and modifications may be made to the above-described embodiments without departing substantially from the spirit and principles thereof. All such modifications and variation are intended to be included herein within the scope of this disclosure.

### EXAMPLES

The various preferred embodiment aspects of the present invention can be used in the separation of many different types of mixed materials containing multiple domains. The following examples are presented anticipating a feedstock derived from ASR, WSR, and/or ESR. However, these examples are only illustrative, and are not meant to limit the scope of the invention.

Automobiles at the end of their life cycle are typically shredded in large automobile shredders to recover primarily the ferrous metals and some of the non-ferrous metals in the scrapped vehicle. The shredded material is in irregular pieces, usually no more than 5 to 6 inches in largest dimension. Various means of magnetic separation are used to remove most of the ferrous metal, and various other means, including eddy current sorting, are used to separate some of the non-ferrous metals. The remainder is referred to as “automobile shredder residue” or ASR. It is rich in plastics.

White goods such as old refrigerators, washers, driers, etc. are recycled through the same type of equipment as old automobiles. In fact, they are often processed through the same equipment on a campaign basis, or even simultaneously with automobiles. As with automobiles shredding, the shredded material is in irregular pieces, usually no more than 5 to 6 inches in largest dimension. Various means of magnetic separation are used to remove most of the ferrous metal, and various other means, including eddy current sorting, are used to separate some of the non-ferrous metals. The remainder is referred to as “white goods shredder residue” or WSR.

Electronic equipment such as computers, televisions, telephones, etc. at the end of their life cycle are typically shredded to recover precious metals to reduce volume. The shredded material is in irregular pieces, usually no more than 5 to 6 inches in largest dimension. Various means are employed to recover the precious metals, and the remainder, rich in mixed polymers, is referred to as electronic shredder residue or ESR.

In accordance with the present invention, ASR, WSR, and/or ESR can be treated as follows to recover individual components. Note that depending on the size and cleanliness of the feedstock, some of these steps may be optional, or the order of some steps may be changed.

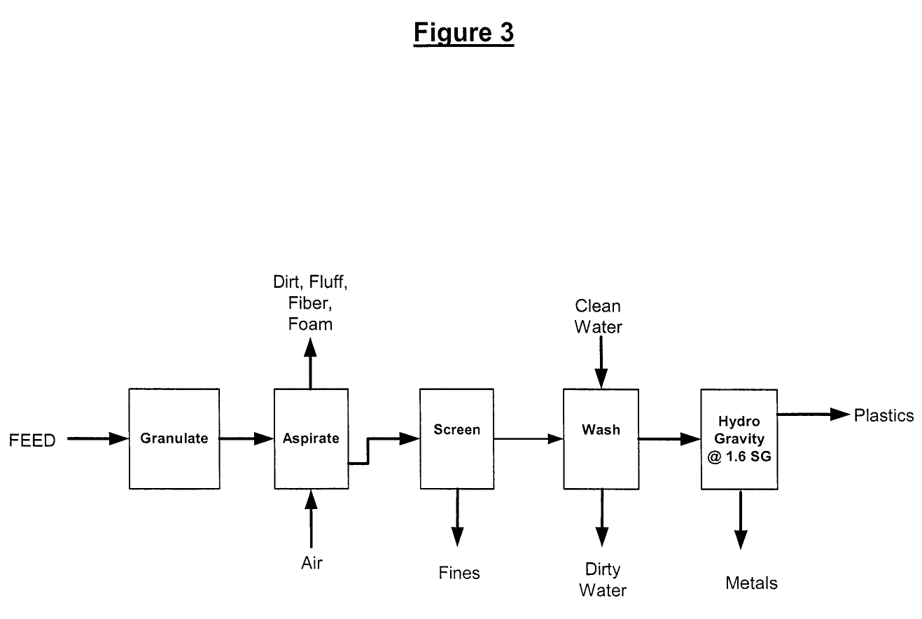

FIG. 3 shows a block flow diagram of a preferred embodiment process that can be used for the treatment of ASR, WSR, and/or ESR by this invention for the recovery of metals and plastics.

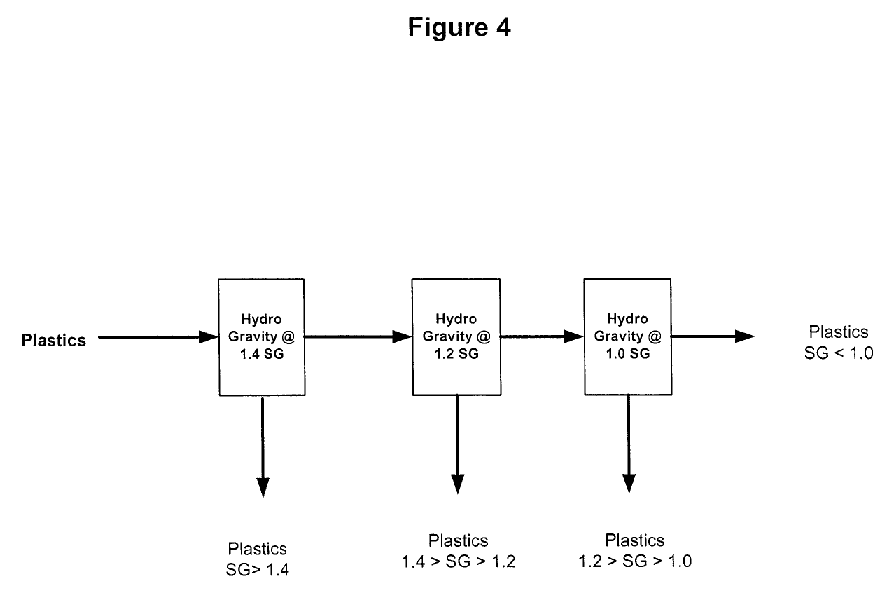

FIG. 4 illustrates a block flow diagram of another preferred embodiment process that can be used to further separate the plastic components.

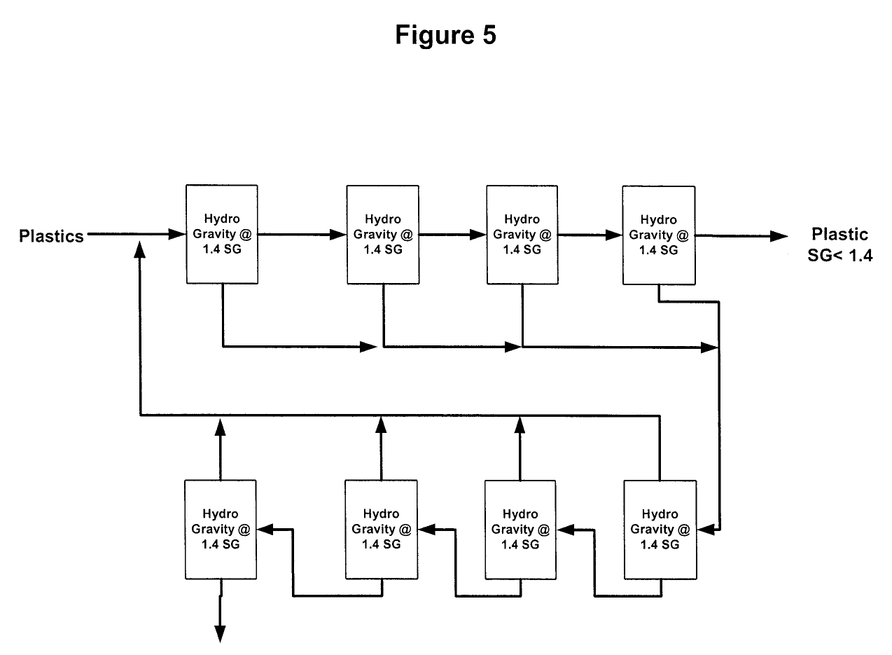

FIG. 5 illustrates a block flow diagram of another preferred embodiment process using a relatively complex hydrogravity stage that uses four hydrogravity tanks to treat and purify the light components of a mixture, and four more hydrogravity tanks to treat and purify the heavy components of a mixture. Depending on the type of mixture and value of the components, one can choose subsets of this arrangement. For example, one may choose to only purify the light components, or only purify the heavy components, or use 4 tanks for purifying the light components and only 2 tanks for purifying the heavy components, or any other combination as dictated by availability and economics.

### Size Reduction

The ASR stream is passed through a granulator that chops the feedstock into smaller particles such that the largest dimension is less than 0.25 inches and up to about 2 inches. This serves to render the particles more flowable in downstream processes, and creates a larger percentage of single-domain particles. Two or more granulators may be used in series to reduce particle size in stages. This helps to minimize over-chopping and the production of fines.

To maximize granulator blade life, a low speed, high torque twin shaft shredder such as those sold by SSI Products of Wilsonville, Oreg. may be used before the granulator to achieve some size reduction. Depending on the initial particle size of the feedstock, any suitable size reduction device or combination of devices can be used in this step.

### Aspiration and Screening

The sized ASR, WSR, and/or ESR stream is passed through an aspirator to remove fiber, paper, and foamed plastics, along with some of the dirt. The heavy fraction from the aspirator is then screened at about 1 to about 2 mm to remove dust and more dirt. The fines from screening can be subjected to other subsequent separations to recover non-ferrous metal particles if there is sufficient economic incentive.

### Washing

The coarse fraction from the screener is mixed with water and a non-foaming or low-foaming surfactant in an agitated vessel to remove residual dirt, oil, tar, etc. from the particles. The particles can optionally be drained and rinsed to remove dirty fluid and surfactant. Excess fluid is then removed from the particles using a spin drier, screener, air blower, or other drying devices to avoid carrying excess water forward into the next step.

### First Hydrogravity Separation

The particles are combined with an aqueous fluid of specific gravity 1.60. Approximately one part by weight of particles is combined with 4 to 20 parts by weight of fluid. The fluid preferentially contains a high percentage of calcium and nitrate ions, and a small amount of non-foaming surfactant. A high sheer mixer is used to ensure that the particles are not agglomerated in the aqueous phase. The aqueous dispersion of particles is introduced into a hydrogravity tank wherein the lighter particles will tend to float and the heavier particles will tend to sink.

Based on relative specific gravity, the plastic components in the ASR will tend to float and the metallic components will tend to sink. To improve the quality of the plastics stream, one or more additional hydrogravity stages can be employed all at approximately the same specific gravity to improve selectivity.

Metallic components, essentially free of plastics are recovered from the heavy product stream and can be further purified by conventional means. Having a metallic stream free of polymers, especially PVC, is very useful since most smelters that would subsequently recycle the non ferrous metals are adverse to polymeric inclusions which tend to create air pollution problems and add dissolved carbon into their metals.

Mixed plastic components, essentially free of metal, are recovered from the light product stream, and are separated into individual components in subsequent processing steps.

Both the floating and sinking streams are optionally de-solutioned using separate screening devices, spin driers such as a dryer from Gala Industries of Eagle Rock, Va., or other such devices to avoid carrying excessive amounts of solution into the next step.

### Second Hydrogravity Separation

In the manner described above, the particles from the plastic-rich stream are combined with an aqueous fluid of specific gravity 1.50. The fluid preferentially contains a high percentage of calcium and nitrate ions, and a small amount of non-foaming surfactant. A high sheer mixer is used ensure that the particles are not agglomerated in the aqueous phase. The aqueous dispersion of particles is introduced into a hydrogravity tank wherein the lighter particles will tend to float and the heavier particles will tend to sink.

In this stage, plastic compounds with a density between 1.50 and 1.60 will tend to sink and can be recovered. Again, multiple tanks can be used to improve the purity of either the floating or sinking streams.

### Subsequent Hydrogravity Separations

In a similar fashion, other hydrogravity separations can be carried out using fluids of specific gravity 1.40, 1.30, 1.20, 1.10, and 1.0 to recover other polymeric species of interest. Each of these steps may involve one or more hydrogravity stages depending on the yield, purity, and value of the plastics in that density range.

The middle density products (1.50-1.20) are rich in PVC, polycarbonates, and nylon. The low density products (1.20-1.0) are rich in acrylonitrile butadiene styrene (ABS), polystyrene, and polyolefins. The specific gravity of any of these polymers can be shifted by the addition of inorganic fillers (which make them heavier), or blowing agents (which make them lighter).

Both the floating and sinking streams are optionally de-solutioned using separate screening devices, spin driers such as a Gala drier, or other such devices to avoid carrying excessive amounts of solution into the next step.

### Froth Flotation

Polyvinyl chloride (PVC) is a desirable plastic compound in the 1.2 to 1.4 specific gravity range. The hydrogravity products in these density ranges, however, can be contaminated with other polymeric compounds, such as rubber or filled polyethylene. To create a more pure PVC stream, a froth flotation system is employed.

About 1 part by weight of the plastic particles is combined with about 4 to 20 parts by weight of water at about 150° F. containing about 0.1 to 0.5% of a light mineral or vegetable oil. This mixture is sprayed through a nozzle onto the surface of a quiescent tank of the same fluid, creating a type of froth. As the fluid and particles break through the surface tension of the fluid in the tank, a large number of small bubbles are formed. These bubbles tend to preferentially attach to the more hydrophobic PVC particles, buoying them towards the surface, even though one would expect them to sink by virtue of their high specific gravity. The floating particles, removed by skimming or other means, are rich in PVC, while the sinking particles are reduced in PVC content.

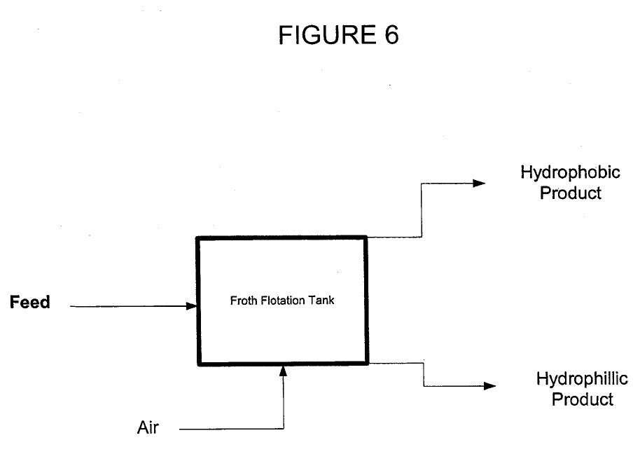

FIG. 6 is a schematic illustration of a single froth flotation unit operation or cell. The froth flotation unit comprises a vessel adapted to receive at least one feed such as an output from a hydrogravity or float-sink operation and provide outputs, such as a first output comprising hydrophobic product, and a second output comprising hydrophilic product. The vessel is adapted to receive at least one feed and provide the noted outputs, and so includes provisions such as inlets, outlets, and connection components. The vessel also is adapted to retain a liquid medium, which is preferably an aqueous liquid. It is also preferred that the vessel include provisions for introducing air into the liquid medium, preferably at one or more lower regions of the vessel so that the air is dispersed relatively uniformly throughout the tank and rises upward from the lower region(s) of the vessel. It is also contemplated to provide provisions for agitating or stirring the aerated liquid medium in the vessel. The vessel may further include one or more screens or filters at the outputs to prevent excessively sized particles or objects from exiting the vessel. As previously noted, the froth flotation unit typically utilizes one or more skimmers or other like assemblies to selectively remove or withdraw particulate material residing in an upper region of the vessel, typically as a result of the froth flotation operation.

The term “aerated” is used herein to refer to the liquid medium of a froth flotation vessel or system receiving air or having previously received air. Typically, such air is administered below the surface of the liquid medium and upon entering the liquid, tends to rise upward in the form of bubbles. The present invention includes other strategies for forming bubbles or otherwise introducing air in a liquid medium of a froth flotation vessel or system. Furthermore, it is contemplated that other gases or vapors may be used instead of air. However, air is preferred in view of its abundancy and essentially free cost.

A typical operation of the froth flotation cell is as follows. Feed is introduced into the vessel. Feed can be in any of the previously described forms, however typically is in the form of a ground or comminuted particulate mixture including at least two types of plastics having the same or similar density, and which are to be separated. As noted, typically the feed to the froth flotation cell is an output, i.e. a floating or a sinking stream of a hydrogravity operation. The froth vessel contains an aqueous medium through which air is administered, to form an aqueous aerated medium.

As a result of differences in the hydrophobicity or hydrophilicity characteristics of the various particulates, the particles exhibiting a greater degree of hydrophobicity than other particulates tend to rise in the vessel and collect along or proximate the top surface of the medium. These particulates can be withdrawn or discharged from the vessel as an output, i.e. the more hydrophobic product. The particulate exhibiting a greater degree of hydrophilicity than other particulates tend to collect in the lower regions of the vessel, and can be withdrawn or discharged from the vessel as an output, i.e. the more hydrophilic product.

The floating particles can be subjected to one or more additional stages of froth flotation to improve PVC quality. The sinking particles can be subjected to one or more additional stages of froth flotation to improve PVC recovery. Depending on the surface condition of the particles, it may be prudent to add a small amount of additional oil in subsequent stages.

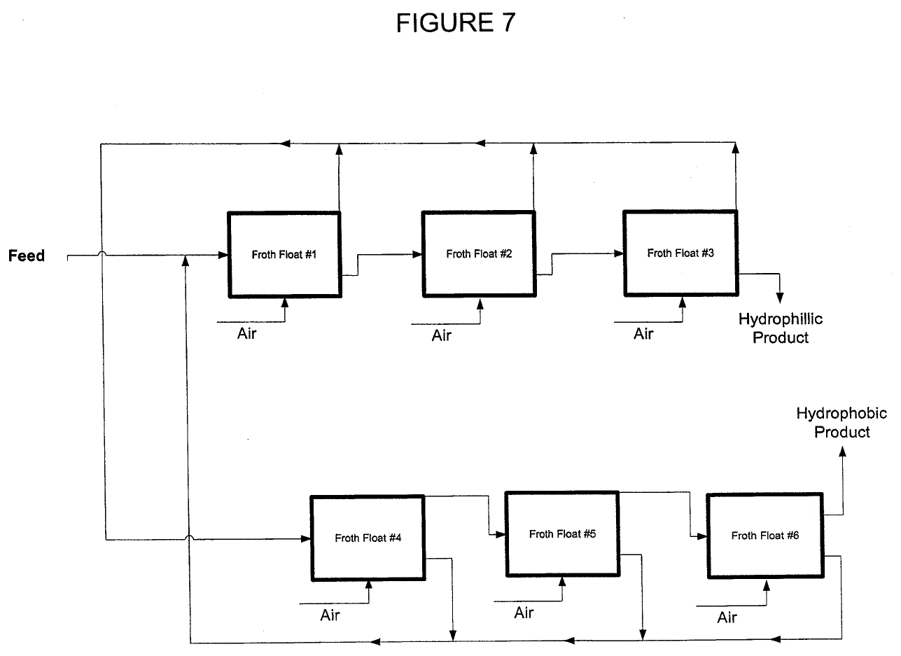

FIG. 7 is a process flow schematic illustrating a froth flotation system comprising a plurality of froth flotation cells. Each cell includes a vessel, each of which may be in the form of the previously described vessel in FIG. 6. The present invention includes the various vessels being in communication with one or more other vessels in nearly any configuration. It will be appreciated that the configuration depicted in FIG. 7 is merely one of potentially many different configurations encompassed by the present invention. With continued reference to FIG. 7, the preferred embodiment system will now be described. Feed is introduced to the vessel of the froth float 1, and specifically, to an aqueous aerated medium retained therein. As noted, the feed may constitute an output from a float-sink operation. A first output generally containing hydrophobic components, and a second output generally containing hydrophilic components are produced. The second output is fed to the vessel of the froth float 2 which produces a first output generally containing hydrophobic components, and a second output generally containing hydrophilic components. The second output is fed to the vessel of the froth float 3 which produces a first output generally containing hydrophobic components, and a second output generally containing hydrophilic components. The first outputs of vessels from the froth floats 1, 2, and 3, i.e. the outputs generally containing hydrophobic components, are directed as feed to the vessel of the froth float 4. Introduction of that feed to the vessel of froth float 4 produces a first output that generally contains hydrophobic components, and a second output that generally contains hydrophilic components. The first output is directed to the vessel of the froth float 5 which produces a first output which generally contains hydrophobic components, and a second output that generally contains hydrophilic components. The first output is directed to the vessel of the froth float 6 which produces a first output which generally contains hydrophobic components, and a second output that generally contains hydrophilic components. The second outputs of vessels from the froth floats 4, 5, and 6, i.e. the outputs generally containing hydrophilic components, are directed to the vessel of the froth float 1 and preferably mixed or otherwise combined with the feed. Each of the vessels preferably receives a supply of air, depicted in FIG. 7 as air flows.

In addition to the various flotation aids noted herein, one or more of the following agents may be used in the froth flotation system to promote separation of the materials. Organic colloids can be used which alter the hydrophilic/hydrophobic surface characteristics of the materials. Suitable examples of organic colloids which can be used in the present invention include tannic acid, a quebracho extract, gelatin, glue, saponin and the like. Other examples of flotation agents include sodium lignin sulfonate and calcium lignin sulfonate. Further examples include pine oil, cresylic acid (also known as xylenol), eucalyptus oil, camphor oil, a derivative of a higher alcohol, methylisobutyl carbinol, pyridine, o-toluidine and the like. Yet another example of a suitable agent is sodium silicate. It is also contemplated that one or more surfactants such as those described in U.S. Pat. No. 5,377,844 could be utilized. Furthermore, depending upon the liquid medium used and the composition of the feed, it may also be possible to utilize one or more of the following agents: polyoxyparafins, alcohols such as methyl isobutyl carbinol (MIBC), and various polyglycols.

After sufficient stages of froth flotation, the particles are de-watered on a screen, spin drier, or other suitable device, dried and packaged.

These froth flotation separation steps can also be applied to mixed plastics found in other hydrogravity streams if the components differ in hydrophobicity. Other examples include separation of acrylonitrile butadiene styrene (ABS) from high impact styrene (HIPS) and PVC from polyethylene terephthalate (PET).

### Fluid and Waste Management

The various aqueous solutions used in the above steps may optionally be purified and recycled as well. The pH can be corrected to near-neutral through the addition of lime or acids such as nitric or sulfuric. Suspended fine solids are removed by filtration and/or flocculation and sedimentation followed by filtration. Densities are corrected by evaporation to increase specific gravity or by dilution to decrease specific gravity.

Any residual material or waste is rendered non-hazardous by blending with appropriate stabilizers, etc. and disposed of in an approved manner.

Fluid management is an important aspect of the preferred embodiment processes. Process fluids should be properly treated and cleaned to ensure reliable operation of the process.

Many other benefits will no doubt become apparent from future application and development of this technology.

It will be appreciated that any of the operations or steps described herein may be combined with any of the other operations or steps described herein, without deporting from the scope of the present invention.

All patents, published applications, and articles noted herein are hereby incorporated by reference in their entirety.

As described hereinabove, the present invention solves many problems associated with previous type approaches, methods, and systems. However, it will be appreciated that various changes in the details, materials and arrangements of operations or steps, which have been herein described and illustrated in order to explain the nature of the invention, may be made by those skilled in the art without departing from the principle and scope of the invention, as expressed in the appended claims.

What is claimed is:

1. A process for separating two or more types of multiple domain feedstock particles, the process consisting essentially of:
reducing the feedstock particle size sufficiently to create largely single-domain particles and a particle size distribution suitable for processing;
optionally cleaning the particles with air and/or aqueous solutions to remove contaminants and fines;
dispersing the particles into an aqueous solution having a specific gravity between that of the lightest and the heaviest particles in the feedstock;
using a dispersion mixer to create a uniform dispersion of individual particles in the aqueous solution;
separating the feedstock particles into individual components or classes of components based on specific gravity using one or more stages to achieve desired recovery and purity;
optionally separating particles or classes of particles of similar specific gravity using one or more stages of froth flotation to achieve desired recovery and purity;
wherein the aqueous solution comprises cations selected from the group consisting of potassium, calcium, sodium, ammonium, and combinations thereof, and further comprises anions selected from the group consisting of nitrate, chloride, bromide, and combinations thereof, at concentrations sufficient to create a fluid with a specific gravity greater than 1.001 relative to the specific gravity of pure water.

2. The process according to claim 1 wherein the aqueous solution comprises at least one of calcium and ammonium cations, and at least one of nitrate and chloride anions dissolved in water.

3. The process according to claim 1 wherein the multiple domain feedstock is derived from at least one of ASR, ESR, and WSR, and comprises a mixture of two or more components selected from the group consisting of plastics, metallics, cellulosic materials, rubber materials, foams, fabrics, and combinations thereof.

4. The process according to claim 3 wherein multiple hydrogravity stages are employed, each using an aqueous salt solution of substantially the same specific gravity to improve product purity.

5. The process according to claim 3 wherein multiple hydrogravity stages are employed using aqueous salt solutions of different specific gravities to separate the multiple domain feedstock in three or more fractions.

6. The process according to claim 3 wherein individual plastic components are recovered.

7. The process according to claim 1 wherein froth flotation is used to recover a stream rich in polyvinyl chloride from a mixture of components all of which have specific gravities in the range of from about 1.30 to about 1.50.

8. The process according to claim 1 wherein the aqueous solution is free from insoluble materials.

9. A process for separating two or more types of multiple domain feedstock particles, the process consisting essentially of:
reducing the feedstock particle size sufficiently to create largely single-domain particles and a particle size distribution suitable for processing;
optionally cleaning the particles with air and/or aqueous solutions to remove contaminants and fines;
dispersing the particles into an aqueous solution having a specific gravity between that of the lightest and the heaviest particles in the feedstock;
using a dispersion mixer to create a uniform dispersion of individual particles in the aqueous solution;
separating the feedstock particles into individual components or classes of components based on specific gravity using one or more stages to achieve desired recovery and purity;
optionally separating particles or classes of particles of similar specific gravity using one or more stages of froth flotation to achieve desired recovery and purity;
wherein the aqueous solution comprises an agent selected from the group consisting of alcohols, glycols, ethers, other water-soluble organics, and combinations thereof, with a specific gravity less than 1.0.

10. The process of claim 9 wherein the aqueous solution comprises an agent selected from the group consisting of methanol, ethanol, isopropanol, diethylene glycol, ethylene glycol monopropyl ether, diethylene glycol diethyl ether, and combinations thereof, to create a fluid with a specific gravity in the range of from about 0.8 to about 1.0 relative to the specific gravity of pure water.

11. The process according to claim 9 wherein the aqueous solution comprises diethylene glycol diethyl ether and water.

12. The process according to claim 9 wherein the multiple domain feedstock is derived from at least one of ASR, ESR, and WSR, and comprises a mixture of two or more components selected from the group consisting of plastics, metallics, cellulosic materials, rubber materials, foams, fabrics, and combinations thereof.

13. The process according to claim 12 wherein multiple hydrogravity stages are employed, each using an aqueous salt solution of substantially the same specific gravity to improve product purity.

14. The process according to claim 12 wherein multiple hydrogravity stages are employed using aqueous salt solutions of different specific gravities to separate the multiple domain feedstock in three or more fractions.

15. The process according to claim 12 wherein individual plastic components are recovered.

16. The process according to claim 9 wherein froth flotation is used to recover a stream rich in polyvinyl chloride from a mixture of components all of which have specific gravities in the range of from about 1.30 to about 1.50.

17. The process according to claim 9 wherein the aqueous solution is free from insoluble materials.

18. A process for producing a plurality of outputs from a particulate feed including a plurality of materials, the process comprising:
introducing the particulate feed to a first hydrogravity vessel containing a liquid medium having a density within the range of densities of the plurality of materials in the feed, whereby a first output is formed that includes the materials having densities less than the density of the liquid medium, and a second output is formed that includes the materials having densities greater than the density of the liquid medium, wherein the liquid medium in the first hydrogravity vessel has a density greater than 1.0 g/cm³ and comprises cations selected from the group consisting of potassium, calcium, sodium, ammonium, and combinations thereof, and anions selected from the group consisting of nitrate, chloride, bromide, and combinations thereof; and
introducing one of the first output and the second output from the first hydrogravity vessel containing a liquid medium having a density substantially the same as the density of the liquid in the first hydrogravity vessel, whereby a third output is formed that includes materials having densities less than the density of the liquid medium in the second hydrogravity tank and a fourth output is formed that includes materials having densities greater than the density of the liquid medium in the second hydrogravity tank.

19. The process of claim 18 wherein the liquid medium in the second hydrogravity tank comprises cations selected from the group consisting of potassium, calcium, sodium, ammonium, and combinations thereof, and anions selected from the group consisting of nitrate, chloride, bromide, and combinations thereof.

20. The process of claim 18 wherein the selected cation is calcium and the selected anion is nitrate in both the first and second hydrogravity tanks.

21. The process of claim 18 wherein the selected cations are calcium and ammonium, and the selected anion is nitrate in both the first and second hydrogravity tanks.

22. The process of claim 18 wherein the liquid medium is an aqueous solution in both the first and second hydrogravity tanks.

23. The process of claim 22 wherein the aqueous solution is free from insoluble materials.

24. The process of claim 18 further comprising:
introducing one of the first output, the second output, the third output, and the fourth output to a froth flotation system including a tank and an aqueous aerated medium disposed in the tank, whereby a portion of materials from the output rise toward an upper region of the aqueous aerated medium thereby forming a fifth output, and a portion of materials from the output sink toward a lower region of the aqueous aerated medium thereby forming a sixth output.

25. A process for recovering a first material from a feedstock comprising the first material and a second material having a density that is the same or similar as the density of the first material, and a third material having a density that is different than the density of the first material, the process comprising:
introducing the feedstock to a float-sink system including a tank containing an aqueous medium comprising cations selected from the group consisting of potassium, calcium, sodium, ammonium, and combinations thereof, and anions selected from the group consisting of nitrate, chloride, bromide, and combinations thereof;
separating the feedstock in the float-sink system into a first output comprising the first material and the second material, and a second output comprising the third material;
directing the first output comprising the first material and the second material to a froth flotation system including a vessel containing an aerated liquid medium; and
separating the first material and the second material in the froth flotation system into a third output comprising the first material and a fourth output comprising the second material.

26. The process of claim 25 wherein the selected cation in the tank of the float-sink system is calcium and the selected anion in the tank of the float-sink system is nitrate.

27. The process of claim 25 wherein the selected cations are calcium and ammonium, and the selected anion is nitrate.

28. The process of claim 25 wherein the density of the liquid greater than 1.0 g/cm³.

29. The process of claim 25 wherein the feedstock is derived from at least one of automobile shredder residue (ASR), electronic shredder residue (ESR), white goods shredder residue (WSR), and combinations thereof.

30. The process of claim 25 wherein the aqueous medium is an aqueous solution free from insoluble materials.
